(19) United States
(12) Patent Application Publication
(10) Pub. No.: US 2013/0220093 A1
(43) Pub. Date: Aug. 29, 2013

(54) GUIDE DEVICE FOR A KNIFE

(71) Applicants: Andreas Bohn, Hilchenbach (DE); Thomas Baur, Hilchenbach (DE); Ulrich Meinhardt, Hilchenbach (DE); Reiner Agsten, Netphen (DE)

(72) Inventors: Andreas Bohn, Hilchenbach (DE); Thomas Baur, Hilchenbach (DE); Ulrich Meinhardt, Hilchenbach (DE); Reiner Agsten, Netphen (DE)

(73) Assignee: SMS SIEMAG AKTIENGESELLSCHAFT, Duesseldorf (DE)

(21) Appl. No.: 13/821,347

(22) PCT Filed: May 19, 2011
(86) PCT No.: PCT/EP11/58092

§ 371 Date: May 13, 2013

(30) Foreign Application Priority Data
Aug. 11, 2010 (DE) 1020100340235

(51) Int. Cl. B26D 7/00

(52) U.S. Cl. CPC B26D 7/0006
USPC 83/171

(57) ABSTRACT

The invention relates to a guide device (1000) for a blade (322) having a slide (320) for receiving the blade (322) and a slide guide (330) and a glide element 300 between the slide guide (330) and the slide (320). A cooling device (205) is arranged for cooling the glide element (300). According to the invention, the cooling device (205) is designed as at least a closed cooling channel (210) or as an open cooling channel (209) having at least one inlet (215, 216) and one outlet (215, 216) for a cooling medium.

The invention relates to a guide device for a blade having a slide for receiving the blade, a slide guide, and a slide element arranged between the slide guide and the slide.

DE 2 122 855 discloses a rectilinear movable upper blade slide provided in sheet shears for trimming metal sheets.

DE 1 502 980 describes flat-blade trimming shears with a driven upper blade beam displaceable along a stand during the entire work movement. An axle connects the upper blade beam with a slide displaceable over two wedge-shaped slide pieces. The slide pieces are connected with a device for adjusting the blade gap.

DE 1 502 870 discloses sheet shears for trimming metal sheets and having adjustable guide for a perpendicular displaceable upper blade carrier. The guides for the upper blade carrier are formed as intermediate slides movable up and down along guides inclined to the plane of the cut of the lower blade carrier and formed in the shear stand.

DE 23 32 898 discloses a flat blade shears for trimming rolled sheets in which the upper blade beams are displaceable over adjustable guides provided on the internal wall of the housing.

DE 1 777 014 describes shears for trimming or separating sheets and including a stationary lower blade and a driven upper blade that is secured against displacement in the longitudinal direction by a guide secured on the stand.

The drawback of the prior art shears consists in that a sliding friction takes place between the movable upper blade carriers and the guides that, together with the heating of the guide surfaces, results in soiling and wear. As the result, operational life of the guide components and the guides is reduced.

The object of the invention is to improve a known guide device for blade in a machine and/or installation such as, e.g., shears for sheets or metal strips, with regard to ease of maintenance and economy, so that the product quality is not reduced by the cutting process.

This object is achieved by features of claim 1. Those are particularly characterized in that a cooling device with a cooling medium for cooling the slide element is provided. With a separately arranged cooling device in the region between the slide and the slide guide, the guide surfaces of the displaceable components and the slide elements are cooled. Thereby, the progressive heating of sliding, relative to each other, components is prevented, which advantageously leads to reduction of wear and reduction of soiling as a result of wear. The cutting frequency of the blade and, thereby, the sliding speed and the surface pressure applied by the sliding element to the slide or the slide guide can all be increased. The output of the installation, i.e., shears, is also increased.

According to a first embodiment, a slide plate is arranged between the slide element and the slide guide and/or between the slide element and the slide, wherein the slide plate is formed with the cooling device. The advantage of this embodiment consists in that in the course of maintenance work, the sliding element or the sliding plate with the cooling device can be dismounted separately, independent from each other, and be repaired or replaced. A further advantage consists in that slide plates formed of different materials and with different cooling devices, which are adapted to respective uses, can be used.

According to the invention the cooling device can be arranged in the slide or the slide guide. The so arranged cooling device increases the cooling effect of the slide guidance and leads, thereby, to reduction of heating of the friction surfaces.

Further, according to the invention, the cooling device is arranged in the sliding element. The advantage of this consists in that the sliding element is subjected to direct cooling. With the slide element having a hollow space for the cooling device, the material mass is reduced and, thereby, the to-be-cooled volume of the sliding element. This accelerates the cooling effect.

Advantageously, the sliding element is self-lubricating. The advantage of this consists in that the combination of the self-lubricating sliding element with the cooling device further reduces wear of the friction surfaces and, thus, eliminates a certain share of soiling.

According to a further embodiment of the invention, the cooling device is formed as a closed cooling channel or as an open cooling channel with at least one inlet and one outlet for the cooling medium. The advantage of this consists in that dependent on manufacturing methods and the device-dependent requirements, a cost-effective solution for forming the cooling channels in the cooling device can be chosen.

It is further provided that as a cooling medium, solid, liquid, or gaseous cooling medium can be used. Dependent on the use of the installation, an economical cooling medium with the best cooling capacity can be selected.

According to the invention, it is contemplated to provide a cover for closing the open cooling channel.

Further advantages and particularities of the invention follow from the sub-claims and the following description in which embodiments of the invention which are shown in the drawings, are described in detail. Further, in addition to the above-described combination of features, separate features or in other combinations are also form an important part of the invention.

### DESCRIPTION OF DRAWING FIGURES

FIG. 1 arrangement of a slide plate, cooling device, and a slide element between a slide and a slide guide;

FIG. 2 a slide plate with inner cooling and an open cooling channel;

FIG. 3 a slide plate with inner cooling and a closed cooling channel.

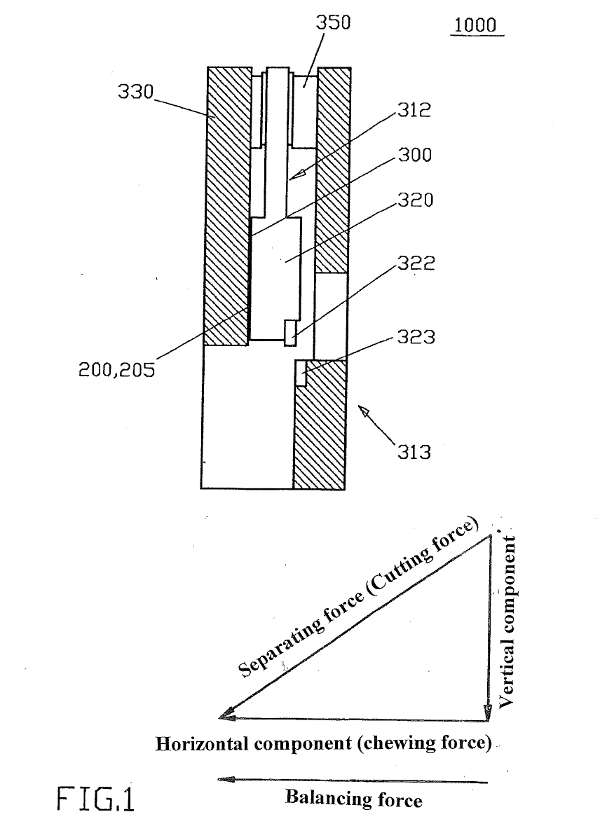

FIG. 1 shows an upper blade carrier 312 driven by a crankshaft 350 and carrying a slide 320 on which a first blade 322 is secured. A second blade 323 is arranged on a lower stationary blade carrier 313. The slide 320 of the upper blade carrier 312 is displaced in a corresponding slide guide 330. A slide element 300 and a cooling device 205 are located between the slide 320 and the slide guide 330. The cutting process describes a force triangle in which the separating force (cutting force) is formed of a vertical component when both the upper blade and the lower blade contact the cut stock and subsequently cut the stock, and a horizontal component, chewing force. The chewing force is transmittal to the slide guide 330 by a slide element 300 and the upper blade carrier 312. For stabilization of the upper blade carrier 312 and for pressing the upper blade carrier against the slide element 300 during advance of the blade carrier toward the cut stock and during the cutting process, the horizontal force component can be increased by an additional balancing force, e.g., by spring, hydraulic or pneumatic cylinder. At that, the ratio of the chewing force and the balancing force is about ⅔ to ⅓.

In the embodiment shown in FIG. 1, the slide element 300 is designed to absorb the chewing pressure of the upper blade carrier 312, which is transmitted by the slide 320, and to guide and support the slide 320. A slide plate 200 and a cooling device 205 are arranged between the slide element 300 and the slide guide 330 and/or between the slide element 300 and the slide 320. The slide plate 200 and the cooling device 205 can be formed as a single structural component. In another embodiment, not shown, the cooling device 205 can be arranged directly in the slide 320, the slide guide 330, or in the slide element. It is particular advantageous when the slide element 300 or the slide plate 200 are self-lubricating. Also, forming the slide element 300 as a sliding strip, not shown, is possible. Other measures for reducing the friction between the surface of the slide element and a friction surface of the counterpart can be undertaken, e.g., by forming a spherical profile.

FIG. 2 shows a first possibility of designing and arranging of the cooling device 205 with at least one open cooling channel 209. The at least one open cooling channel 209, viewed from the attachment surface 221 of a structural component, is milled in the base body of the structural component. In the shown view, the structural component corresponds to the slide element 300. In this way, the open cooling channel 209 can also be provided in the slide guide 330, or the slide 320, or in an additional, here not shown, plate. A surface of the counterpart to which the structural component is screwed, serves as a cover and a seal. For closing the at least one cooling channel 209, a separate cover can be provided. At least one inlet 215, 216 and at least one outlet 216, 215 for the cooling medium adjoin the cooling channel at suitable locations.

To this end, e.g., simple conduits in form of hoses, bores, attachment sleeves, plug or screw connection for the inlet and outlet 215, 216 can be provided.

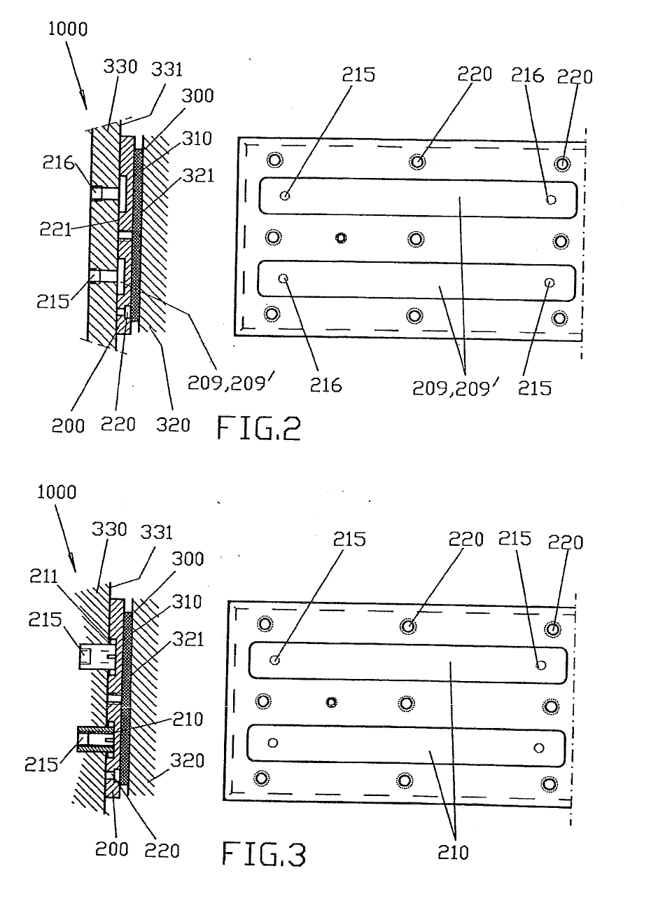

FIG. 3 shows the cooling device 205 with at least one closed cooling channel 210 with at least one inlet and at least one outlet 215, 216 for the cooling medium. The closed cooling channel 210 can, e.g., be integrated in the interior of the structural component in form of bores or closes tubular conduits.

It is possible to form the structural component from two mirror-symmetrical halves each provided with a one-sided milled cooling channel-half 209′, as shown in FIG. 2. The two halves are aligned and adjoin each other with their sides having the open cooling channel halves 209′, so that upon being attached, they form a common closed cooling channel 210 in the interior of the structural component. Both structural halves are finally welded with each at least pressure-tight or gas-tight dependent on the used solid, liquid, or gaseous cooling medium.

All of the features, which are described above with reference to the drawings, can advantageously be combined or supplemented for forming the device.

### LIST OF REFERENCE NUMERALS

1000 Device
200 Sliding plate
205 Cooling device
209 Open cooling channel
209′ Cooling channel half
210 Closed cooling channel
211 Cover
215 Connection for inlet/outlet
216 Connection for inlet/outlet
220 Attachment bores
221 Attachment surface
300 Sliding element
310 Friction surface
312 Upper blade carrier
313 Lower blade carrier
320 Slide
321 Slide contact surface
322 First blade
323 Second blade
330 Slide guide
331 Slide guide contact surface
350 Crankshaft

1. A guide device (1000) for a blade (322), comprising:
a slide (320) for receiving the blade (322);
a slide guide (330);
a slide element (300) between the slide guide (330) and the slide (320), and
a cooling device (205) with cooling medium for cooling the slide element (300),
characterized in that
a slide plate (200) is arranged between the slide element (300) and the slide guide (330) and/or between the slide element (300) and the slide (320); and
the slide plate (200) is formed with the cooling device (205).

2. (canceled)

3. A device according to one of preceding claims claim 1,
characterized in that
the cooling device (205) is arranged in the slide (320).

4. A device according to claim 1,
characterized in that
the cooling device (205) is arranged in the slide guide (330).

5. A device according to claim 1,
characterized in that
the cooling device (205) is arranged in the slide element (300).

6. A device according to claim 1,
characterized in that
the slide element (300) is self-lubricating.

7. A device according to claim 1,
characterized in that
the cooling device (205) is formed as a closed cooling channel (20) or as an open cooling channel (209) with at least one inlet (215, 216) and one outlet (215, 216) for the cooling medium.

8. A device according to claim 1,
characterized in that
the cooling medium is solid, liquid or gaseous.

9. A device according to claim 7,
characterized in that
a cover (211) for closing the open cooling channel (209) is provided.
